(19) United States
(12) Patent Application Publication
(10) Pub. No.: US 2023/0183876 A1
(43) Pub. Date: Jun. 15, 2023

(54) Li ION RECOVERY MEMBER AND Li RECOVERY DEVICE USING SAME

(71) Applicant: IDEMITSU KOSAN CO.,LTD., Chiyoda-ku (JP)

(72) Inventors: Futoshi UTSUNO, Ichihara-shi (JP); Satoshi KATSUMATA, Chiba-shi (JP); Tsuyoshi HOSHINO, Chiba-shi (JP)

(73) Assignee: IDEMITSU KOSAN CO.,LTD., Chiyoda-ku (JP)

(21) Appl. No.: 17/995,663

(22) PCT Filed: Apr. 9, 2021
(86) PCT No.: PCT/JP2021/015099

§ 371 Date: Oct. 6, 2022

(30) Foreign Application Priority Data
Apr. 10, 2020 (JP) 2020-071150

(51) Int. Cl. C25C 7/04; C25C 7/02; C25C 1/02

(52) U.S. Cl. CPC C25C 7/04; C25C 7/02; C25C 1/02

(57) ABSTRACT

A Li ion recovery member and a Li recovery device may prevent occurrence of breakage of a permselective membrane and implement stable Li ion recovery for a long period of time even when a size of a Li recovery device is increased. The Li ion recovery member may include: a permselective membrane including a Li ion conductor made of an inorganic substance; electrodes; and a reticular elastic body, in which the electrodes are provided on at least one main surface side of the permselective membrane, at least one electrode of the electrodes is a porous electrode or a membrane electrode, and the porous electrode or the membrane electrode is sandwiched between the reticular elastic body and the permselective membrane. The Li recovery device may include a Li ion recovery electrolytic cell including the Li ion recovery member and configured to recover Li ions by electrodialysis.

### TECHNICAL FIELD

The present invention relates to a Li ion recovery member and a Li recovery device using the same.

### BACKGROUND ART

With a rapid spread of information-related devices and communication devices such as personal computers, video cameras, and mobile phones in recent years, development of batteries used as power sources for these devices has been regarded as important. In the related art, an electrolytic solution containing a combustible organic solvent has been used for a battery used for such an application, but a battery in which the electrolytic solution is replaced with a solid electrolyte layer has been developed since, by making the battery into an all-solid state, the combustible organic solvent is not used in the battery, a safety device can be simplified, and a production cost and productivity are excellent.

Lithium secondary batteries and the like are used as batteries for use in the applications described above, and in recent years, use for hybrid cars and electric vehicles that are developed to cope with carbon dioxide gas emission regulations has also been studied. Therefore, there has been an urgent need to secure a lithium source more than ever, and as a part thereof, a technique for recovering lithium by recycling a lithium secondary battery has been developed (see, for example, PTL 1). As a technique for recovering sodium ions, an ion exchange membrane electrolytic cell using an ion exchange membrane is known (see, for example, PTL 2).

### CITATION LIST

### Patent Literature

PTL 1: JP 2015-034315 A
PTL 2: JP 2000-178782 A

### SUMMARY OF INVENTION

### Technical Problem

In the related art, the ion exchange membrane electrolytic cell described in PTL 2 is known, but an ion exchange membrane (Nafion N-962 manufactured by DuPont) is used, and lithium ions cannot be selectively recovered. On the other hand, the technique described in PTL 1 uses a permselective membrane formed of an ion conductor to recover metal ions from a raw liquid containing metal ions such as lithium. Among the metal ions, there is no ion exchange membrane capable of recovering lithium ions, and lithium ions are attempted to be recovered by using a lithium ion conductor as the permselective membrane as in the technique described in PTL 1.

In the technique described in PTL 1, as the lithium ion conductor used as the permselective membrane, a plate-shaped sintered body made of a powder of a metal oxide or the like such as a super lithium ion conductor having a Li-substituted NASICON-type crystal or the like is used. In a case of increasing a recovery scale of lithium ions, it is required to increase a size of the permselective membrane, but it is extremely difficult to increase the size of the permselective membrane, which is the sintered body. Further, even if the size of the permselective membrane can be increased, as the size of the permselective membrane is increased, there is a remarkable problem in that breakage during movement, attachment to the device, cracking due to vibration of the device during lithium ion recovery, and the like are likely to occur. In addition, since the large-sized permselective membrane itself is heavy, it is extremely difficult to maintain the permselective membrane in a state in which water leakage or the like of the device is prevented during lithium ion recovery. In addition, in the technique described in PTL 1, a positional relationship between the permselective membrane and the electrode is important in terms of improving a lithium recovery rate, but there is no disclosure of a specific method relating to arrangement and the like in a case of a large-sized device. With an increase in demand for lithium, improvement in lithium recovery efficiency has been required more than ever, and at the same time, an increase in recovery scale of lithium ions is required. Under the above circumstances, there is a problem that it is not possible to sufficiently cope with the increase in recovery scale.

The present invention has been made in view of such circumstances, and an object of the present invention is to provide a Li ion recovery member in which an occurrence of breakage of a permselective membrane can be prevented and stable Li ion recovery can be implemented for a long period of time even when a size of a Li recovery device is increased, and a Li recovery device using the same.

### Solution to Problem

As a result of intensive studies to solve the above problem, the present inventors have found that the above problem can be solved by the following invention.

1. A Li ion recovery member including:

a permselective membrane including a Li ion conductor made of an inorganic substance; and

electrodes, in which

the electrodes are provided on at least one main surface side of the permselective membrane,

at least one of the electrodes is a porous electrode or a membrane electrode, and

the porous electrode or the membrane electrode is sandwiched between a reticular elastic body and the permselective membrane.

2. The Li ion recovery member according to the above 1, in which the porous electrode or the membrane electrode is provided on both main surface sides of the permselective membrane.

3. The Li ion recovery member according to the above 1 or 2, further including:

an electrode made of a rigid conductive porous plate.

4. The Li ion recovery member according to the above 3, in which the porous electrode or the membrane electrode is provided on one main surface side of the permselective membrane, and the rigid conductive porous plate is provided on the other main surface of the permselective membrane.

5. The Li ion recovery member according to the above 3, in which the porous electrode or the membrane electrode and the rigid conductive porous plate are provided on one main surface side of the permselective membrane.

6. The Li ion recovery member according to the above 5, in which the porous electrode or the membrane electrode and the rigid conductive porous plate are provided on both main surface sides of the permselective membrane.

7. The Li ion recovery member according to the above 5 or 6, in which the rigid conductive porous plate is provided so as to sandwich the porous electrode or the membrane electrode and the reticular elastic body.

8. The Li ion recovery member according to any one of the above 1 to 7, in which

the permselective membrane includes a plurality of permselective membrane units and an adhesive portion, which are disposed on a same plane,

the adhesive portion is provided in a lattice shape or a honeycomb shape, and

the plurality of permselective membrane units are disposed in regions partitioned by the adhesive portion and are bonded to one another by the adhesive portion.

9. The Li ion recovery member according to the above 8, in which the adhesive portion is provided with a current collector.

10. The Li ion recovery member according to any one of the above 1 to 9, in which the Li ion conductor contains an oxide or oxynitride containing Li.

11. A Li recovery device including:

a Li ion recovery electrolytic cell including the Li ion recovery member according to any one of the above 1 to 10 and configured to recover Li ions by electrodialysis.

12. The Li recovery device according to the above 11, further including:

a plurality of the Li ion recovery members, in which

the plurality of Li ion recovery members are connected such that a main surface of the permselective membrane of one Li ion recovery member and a main surface of the permselective membrane of another Li ion recovery member face each other.

### Advantageous Effects of Invention

According to the present invention, it is possible to provide a Li ion recovery member in which an occurrence of breakage of the permselective membrane can be prevented and stable Li ion recovery can be implemented for a long period of time even when a size of a Li recovery device is increased, and a Li recovery device using the same.

### BRIEF DESCRIPTION OF DRAWINGS

FIG. 1 is a schematic view showing a cross section of a mode of a Li ion recovery member according to the present embodiment.

FIG. 2 is a schematic view showing a cross section of a mode of the Li ion recovery member according to the present embodiment.

FIG. 3 is a schematic view showing a front surface and a cross section of a form of a permselective membrane in the Li ion recovery member according to the present embodiment.

FIG. 4 is a schematic view showing a cross section of a mode of a Li ion recovery electrolytic cell in the Li recovery device according to the present embodiment.

FIG. 5 is a schematic view showing a cross section of a mode of the Li ion recovery electrolytic cell in the Li recovery device according to the present embodiment.

FIG. 6 is a schematic view showing a cross section of a mode of the Li ion recovery electrolytic cell in the Li recovery device according to the present embodiment.

### DESCRIPTION OF EMBODIMENTS

Hereinafter, a Li ion recovery member and a Li recovery device according to one embodiment of the present invention (hereinafter referred to as “the present embodiment”) will be described below. The Li ion recovery member and the Li recovery device according to one embodiment of the present invention are merely one embodiment for each of the Li ion recovery member and the Li recovery device of the present invention, and the present invention is not limited to the Li ion recovery member and the Li recovery device according to the embodiment of the present invention. Further, in the present specification, lithium means both lithium and lithium ions, and should be interpreted as appropriate as long as technical contradiction does not occur.

### [Li Ion Recovery Member]

The Li ion recovery member according to the present embodiment includes a permselective membrane including a Li ion conductor made of an inorganic substance, and electrodes. The electrodes are provided on at least one main surface side of the permselective membrane, at least one of the electrodes is a porous electrode or a membrane electrode, and the porous electrode or the membrane electrode is sandwiched between a reticular elastic body and the permselective membrane.

As described above, it is difficult to increase a size of the permselective membrane, and there is a problem in strength and a problem in weight even if the size of the permselective membrane can be increased, and it is extremely difficult to cope with an increase in size of a device by increasing the size of the permselective membrane. In this regard, the Li ion recovery member according to the present embodiment has a configuration in which the porous electrode or the membrane electrode is sandwiched between the reticular elastic body and the permselective membrane. According to the Li ion recovery member of the present embodiment, when an increase in size is required, it is possible to cope with the increase in size by combining a plurality of the configurations instead of increasing a size of the configuration itself.

In addition, as described above, when the size of the permselective membrane is increased, a problem of an occurrence of breakage due to a decrease in strength occurs. In this regard, since it is easy to increase a size of the porous electrode, by using the porous electrode having an increased size, the breakage of the permselective membrane can be prevented from occurring and Li ions can be stably recovered for a long period of time. In addition, when the size of the permselective membrane is increased, it is also necessary to consider an arrangement of the permselective membrane and the electrode. In this regard, since the Li ion recovery member according to the present embodiment can stably recover Li ions by the configuration described above, it is possible to cope with the increase in size of the device by simply combining the plurality of configurations without considering the arrangement of the permselective membrane and the electrode.

Therefore, in the related art as disclosed in PTL 1, it is extremely difficult to cope with the increase in size of the device, but according to the Li ion recovery member of the present embodiment, it is possible not only to easily cope with the increase in size of the permselective membrane regardless of whether the size of the permselective membrane is increased, but also to prevent the occurrence of the breakage of the permselective membrane and implement the stable Li ion recovery for a long period of time.

### (Permselective Membrane)

The permselective membrane used in the present embodiment contains a Li ion conductor made of an inorganic substance. In the case of only recovering Li ions, it is extremely difficult to perform recovering with an ion exchange membrane made of an organic substance. In the present embodiment, instead of the ion exchange membrane made of an organic substance, the permselective membrane containing the Li ion conductor made of the inorganic substance is adopted, so that it is possible to stably recover Li ions which are difficult to recover by the ion exchange membrane.

The Li ion conductor made of the inorganic substance can be used without particular limitation as long as the Li ion conductor is made of an inorganic substance and has Li ion conductivity, and preferred examples of the Li ion conductor made of the inorganic substance include a super Li ion conductor. When the super Li ion conductor is used, Li recovery efficiency can be improved by increasing an ion current of Li ions flowing between electrodes. Here, Li ions contained in an aqueous solution are present as Li hydrated ions in which water molecules are coordinated around Li ions. Therefore, in order to further increase the ion current, it is effective to implement a situation in which water molecules are easily removed from a surface of the permselective membrane (interface between the permselective membrane and a raw liquid).

Therefore, a Li adsorption layer that adsorbs Li ions (excluding hydrates) in a Li ion extraction solution is preferably formed on the surface of the permselective membrane. That is, the permselective membrane is preferably subjected to a surface Li adsorption treatment. As described later, the Li adsorption layer is preferably formed by modifying a surface of a material constituting the permselective membrane.

Preferred examples of a material of the Li ion conductor made of the inorganic substance constituting a permselective membrane body include an oxide and oxynitride containing Li as described below. That is, the permselective membrane preferably contains the following oxides and oxynitrides containing Li.

Examples of the oxide containing Li include lithium lanthanum titanate: (Liₓ,La_{y})TiO_{z} (here x=3a−2b, y=⅔−a, z=3−b, 0<a≤⅙, 0≤b≤0.06, x>0) (hereinafter also referred to as “LLTO”), lithium lanthanum zirconate: Li₇La₃Zr₂O₁₂ (hereinafter also referred to as “LLZO”), lithium lanthanum niobate: Li₅La₃Nb₂O₁₂, and lithium lanthanum tantalate: Li₅La₃Ta₂O₁₂. More specifically, Li_{0.29}La_{0.57}TiO₃ (a≈0.1, b≈0) can be used as LLTO.

These materials can be obtained, for example, as a sintered body obtained by mixing particles formed of this material with a sintering aid or the like and sintering the mixture at a high temperature (1000° C. or higher). In this case, a surface of the Li permselective membrane can also be formed as a porous structure in which fine particles formed of LLTO are bonded (sintered), so that an effective area of a surface of the Li permselective membrane body can be increased. The same applies not only to LLTO but also to other oxides and oxynitrides containing Li described later.

Examples of the super Li ion conductor that can be used as the material constituting the permselective membrane body include, as the oxide containing Li, Li_{1+x+y}Alₓ(Ti,Ge)₂₋ₓSi_{y}P_{3-y}O₁₂ (here, 0≤x≤0.6, 0≤y≤0.6) (Li₂O—Al₂O₃—SiO₂—P₂O₅—TiO₂—GeO₂-based, hereinafter also referred to as “LASiPTiGeO”), which is a Li-substituted Na super ionic conductor (NASICON) crystal, in addition to the above LLTO, LLZO, and the like.

Preferable examples of the oxynitride containing Li include lithium oxynite phosphate (Li₃PON, hereinafter also referred to as “UPON”), a nitride of LLTO (LLTON), a nitride of LLZO (LLZON), and a nitride of LASiPTiGeO (LASiPTiGeON).

The super Li ion conductor such as an oxide or an oxynitride containing Li contains Li as one of constituent elements thereof, and Li ions outside the crystal migrate between Li sites in the crystal, thereby exhibiting ion conductivity. Li ions flow through the Li permselective membrane body, but sodium ions cannot flow through the Li permselective membrane. At this time, Li ions (Lit) conduct in the crystal, and Li hydrate ions present in the raw liquid together with Li ions are not introduced to the Li sites, and thus do not conduct in the crystal. This point is the same as the Li permselective membrane described in WO 2015/020121.

Here, if only a large amount of Li ions are particularly adsorbed on the surface of the permselective membrane body by the Li adsorption layer, water molecules of the Li hydrated ions are removed during the adsorption, and since only Li ions are present, conduction efficiency of Li ions from a raw liquid side (one main surface side) to a recovery liquid side (the other main surface side) in the Li permselective membrane body (ion current flowing through the permselective membrane body) can be increased.

The permselective membrane may be formed of a single permselective membrane, or may be formed as an aggregate of a plurality of permselective membranes. The aggregate of the plurality of permselective membranes is preferably, for example, in a form shown in (3-1) in FIG. 3, that is, the aggregate includes a plurality of permselective membrane units 21 and an adhesive portion 22 which are disposed on the same surface, the adhesive portion is provided in a lattice shape, and the plurality of permselective membrane units are disposed in regions partitioned by the adhesive portion in the lattice shape and are bonded to one another by the adhesive portion. In addition, in (3-1) in FIG. 3, a case of the adhesive portion having the lattice shape is shown, but the shape of the adhesive portion is not limited to the lattice shape, and may be a line shape (stripe shape), a honeycomb shape, or the like, and a honeycomb shape is preferred from a viewpoint of shape stability.

Examples of an adhesive used for the above adhesive portion include an epoxy resin, a silicone resin, and a ceramic-containing adhesive which have resistance to alkalinity.

In addition, as shown in (3-2) in FIG. 3, in a case in which the permselective membrane is the aggregate of the plurality of permselective membranes described above, it is preferable that a current collector 23 is provided in the adhesive portion 22. Accordingly, it possible to reliably energize the electrodes while effectively utilizing the surface of the permselective membrane. In addition, since a required number of permselective membrane units can be combined according to a desired scale, it is possible to more easily cope with an increase in size.

A size of the permselective membrane unit is usually 10 cm or more and 3000 cm or less in length and 10 cm or more and 2000 cm or less in width, and preferably 30 cm or more and 2800 cm or less in length and 30 cm or more and 1800 cm or less in width. A thickness of the permselective membrane unit is usually 0.1 cm or more and 10 cm or less, and preferably 1 cm or more and 6 cm or less. When the size of the permselective membrane unit is within the above range, the permselective membrane unit can be easily produced and has sufficient strength.

The current collector is preferably provided on at least one main surface side of the permselective membrane, and is more preferably provided on both main surface sides.

As a material constituting the current collector, a material having high electrical conductivity is preferably used, and a material having resistance to alkalinity is preferably used since it is assumed that the current collector is used in an alkaline atmosphere. As such a material, in addition to SUS, Ti, Ti—Ir alloys, and the like, which are materials that can be used as electrodes to be described later, nickel, a nickel alloy, carbon felt, and the like can also be used.

### (Electrode)

At least one of the electrodes used in the present embodiment is a porous electrode or a membrane electrode.

The porous electrode is an electrode including a porous body having pores, and specific examples thereof include a carbon felt, a carbon sheet, a metal nonwoven fabric, and a metal mesh body. As a metal constituting these porous electrodes, a metal generally used as the electrode can be used without limitation, and it is preferable to use a metal material which does not cause an electrochemical reaction and has resistance to alkalinity, and preferred examples thereof include SUS, Ti, and Ti—Ir alloys.

The porous electrode is not particularly limited as long as the electrode includes a porous body having pores, and the pore usually has an opening area of about 0.05 mm² to 1.0 mm², and preferably 0.1 mm² to 0.5 mm². A ratio of a total opening area to a surface area of the porous body is preferably 10% or more, and more preferably 20% or more, and an upper limit thereof is preferably 50% or less, and more preferably 40% or less.

When the porous electrode has the above pores, the current is easy to uniformly flow, and the porous electrode is in surface contact with the permselective membrane and has flexibility, so that local stress or the like can be prevented. In addition, when the size of the permselective membrane is increased, it is easy to increase a size of the porous electrode such as a metal nonwoven fabric. Since the permselective membrane serves as a partition wall between the raw liquid and a recovery liquid during Li ion recovery, the permselective membrane is in a state in which a pressure is applied in a manner of not causing water leakage, but when the pressure applied to the permselective membrane is non-uniform or there is a hard protrusion, the permselective membrane may be broken. Therefore, by using the porous electrode and providing the porous electrode on both surfaces of the permselective membrane to have the same structure on both surfaces of the permselective membrane, it is possible to equalize the pressure received from both sides over the entire surface of the permselective membrane. As a result, it is possible to prevent the permselective membrane from being broken due to the local stress applied thereto, and thus it is easy to implement stable Li ion recovery for a long period of time. In addition, by providing the porous electrode on both surfaces of the permselective membrane, the number of contact points between the permselective membrane and the porous electrode increases on both surfaces of the permselective membrane, and uniform and large electrolysis is applied in the surfaces of the permselective membrane, so that improvement of a recovery rate of Li ions can be expected.

The membrane electrode is an electrode in a film manner, and examples thereof include a metal film made of a metal forming the porous electrode described above. In this case, a thickness of the metal film may be appropriately determined depending on desired performance, a size, and the like, and is not unconditionally determined since the thickness varies depending on a film forming method. For example, when a vapor deposition method, a sputtering method, or the like is adopted, the thickness is usually about 1 nm to 5000 nm, preferably 10 nm to 3500 nm, more preferably 50 nm to 2500 nm, and still more preferably 100 nm to 2000 nm. When the metal film is formed by applying a liquid composition containing the metal forming the electrode, the thickness is usually about 0.1 μm to 100 μm, preferably 0.5 μm to 70 μm, more preferably 1 μm to 50 μm, and still more preferably 5 μm to 20 μm.

In the present embodiment, the porous electrode or the membrane electrode may be adopted as either an anode or a cathode.

Both the porous electrode and the membrane electrode may be used alone, or may be used in combination.

In the present embodiment, an electrode made of a rigid conductive porous plate may be further provided as an electrode other than the porous electrode or the membrane electrode described above, which is the at least one of the electrodes. When the conductive porous plate is rigid, parallelism among the plurality of permselective membranes can be maintained, and since the conductive porous plate is rigid, it is possible to uniformly apply a pressure to the permselective membranes at a higher pressure. Therefore, the breakage of the permselective membrane is prevented from occurring, and stable Li ion recovery is easily implemented for a long period of time.

Preferred examples of the rigid conductive porous plate include metal plates having openings, such as an expanded metal and a punched metal. Examples of a metal constituting the expanded metal, the punched metal, and the like include those exemplified as the metal that can be used for the electrode described above.

When the metal plate has an opening, a ratio of an area of the opening to an entire area is preferably 5% to 50%, more preferably 10% to 45%, and still more preferably 20% to 35%. When the ratio of the opening is within the above range, the local stress can be prevented, and thus, the breakage of the permselective membrane is prevented from occurring, and the stable Li ion recovery is easily implemented for a long period of time.

### (Reticular Elastic Body)

The reticular elastic body used in the present embodiment is provided for fixing the porous electrode or the membrane electrode, which is the at least one of the electrodes, to the permselective membrane. These electrodes are sandwiched between the reticular elastic body and the permselective membrane, and by using the reticular elastic body whose size is easily to be increased, even when the size of the device is increased, particularly when the size of the device is increased by increasing the size of the permselective membrane, the electrodes such as the porous electrode and the membrane electrode can be fixed so as to be reliably in contact with the permselective membrane while preventing the occurrence of the breakage of these electrodes.

The reticular elastic body can be used without particular limitation as long as the electrode such as the porous electrode or the membrane electrode can be fixed so as to be in contact with the permselective membrane to an extent that the electrode and the permselective membrane are not broken, and preferred examples of the reticular elastic body include a conductive or insulating elastic mat. When the pressure applied to the permselective membrane is non-uniform or there is a hard protrusion, the permselective membrane may be broken, but by adopting the conductive or insulating elastic mat described above as the reticular elastic body, the breakage of the permselective membrane is prevented from occurring, and the stable Li ion recovery is easily implemented for a long period of time.

Preferred examples of the conductive elastic mat include metal meshes obtained by weaving metal wires by various methods, such as a plain weave metal mesh, a plain dutch weave metal mesh, a twill weave metal mesh, a twill dutch weave metal mesh, a herringbone weave metal mesh, and a knitted weave metal mesh, crimp metal meshes obtained by crimping these metal meshes, and an aggregate of metal wool. Among these, the conductive elastic mat is preferably a knitted weave metal mesh. In addition to these metal meshes, a flexible material, for example, a spring (metal coil body) can be used. When the spring is used, the spring may be provided such that a direction of expansion and contraction thereof is parallel to the main surface of the permselective membrane.

By using such an elastic mat, the electrode is easily fixed so as to be in contact with the permselective membrane to the extent that the electrode and the permselective membrane are not broken, the local stress is easily prevented, and a rise of bubbles such as hydrogen generated during use is promoted, so that more stable use becomes possible. In the present embodiment, when these metal meshes are used, a plurality of metal meshes may be used in combination in order to have a desired thickness.

From the same viewpoint, when a metal mesh is used as the elastic mat, a metal mesh having an opening of about 0.5 mm to 20 mm may be used, and a metal mesh having an opening of about 1 mm to 10 mm is preferred. When a crimp metal mesh is used, a difference in process between peaks and valleys of the crimp is usually about 1 mm to 40 mm, and preferably 2 mm to 30 mm.

The reticular elastic body has elasticity, and preferably has the following properties from the viewpoint of easily fixing the electrode so as to be in contact with the permselective membrane to the extent that the electrode and the permselective membrane are not broken, and further preventing the local stress. The following properties are common in both cases in which the reticular elastic body is the above-described metal mesh and in which the reticular elastic body is the spring (metal coil body).

A repulsive force when the reticular elastic body is compressed and deformed by 50% in a thickness direction is preferably 30 g/cm² to 50 g/cm², and more preferably 35 g/cm² to 45 g/cm². A repulsive force when the reticular elastic body is compressed and deformed by 20% in the thickness direction is preferably 10 g/cm² to 30 g/cm², and more preferably 15 g/cm² to 25 g/cm².

As for spring elasticity, there is no particular limit to a spring constant as long as the spring elasticity has the above-described repulsive force, and a deformation width in the thickness direction in which the spring constant indicates a constant value is preferably 1 mm to 30 mm, and more preferably 2 mm to 20 mm.

A porosity of the reticular elastic body during use is preferably 20% or more, and more preferably 30% or more. When the electrode is used in a state having such a porosity, the electrode is easily fixed so as to be in contact with the permselective membrane, the local stress is easily prevented, and a rise of bubbles such as hydrogen generated during use is promoted, so that more stable use becomes possible.

A material constituting the reticular elastic body is not particularly limited, and in consideration of being able to be used as the current collector from the viewpoint of more efficiently recovering Li ions, a material having high electrical conductivity is preferably used, and a material having resistance to alkalinity is preferably used since it is assumed that the current collector is used in an alkaline atmosphere.

As such a material, in addition to SUS, Ti, Ti—Ir alloys, and the like, which are materials that can be used as the electrodes described above, carbon steel, nickel, a nickel alloy, and the like can also be used. In consideration of cost, for example, a material obtained by plating carbon steel or SUS with nickel is preferred.

As the insulating elastic mat, it is preferable to use a material that has a certain level of strength or more, that is permeable to an aqueous solution containing ions to be recovered, and that further has chemical stability to the aqueous solution, and is preferably a nonwoven fabric, a separator, or the like. The non-woven fabric is preferably a plant fiber, an animal fiber, a mineral fiber, or a chemical fiber. The chemical fiber is preferably rayon, nylon, polyester, an acrylic fiber, or an aramid fiber. The separator is preferably a polyolefin-based or urethane-based resin having fine pores. Depending on a form of a recovery member, i.e., a stack type, a cylindrical type, or the like, the recovery member can also be served as a spacer through which the raw liquid and the recovery liquid pass. Unlike the conductive elastic mat, the insulating elastic mat does not have the function of the current collector, but there is an advantage that an unnecessary electrode reaction does not occur.

The elastic mat may be the above-described elastic mat alone, or a plurality of elastic mats made of the same or different materials may be stacked in layers. For example, the insulating elastic mat may be used alone, the conductive elastic mat may be used alone, a plurality of insulating elastic mats may be used in combination, a plurality of conductive elastic mats may be used in combination, or an insulating elastic mat and a conductive elastic mat may be used in combination.

### (Installation Positional Relationship)

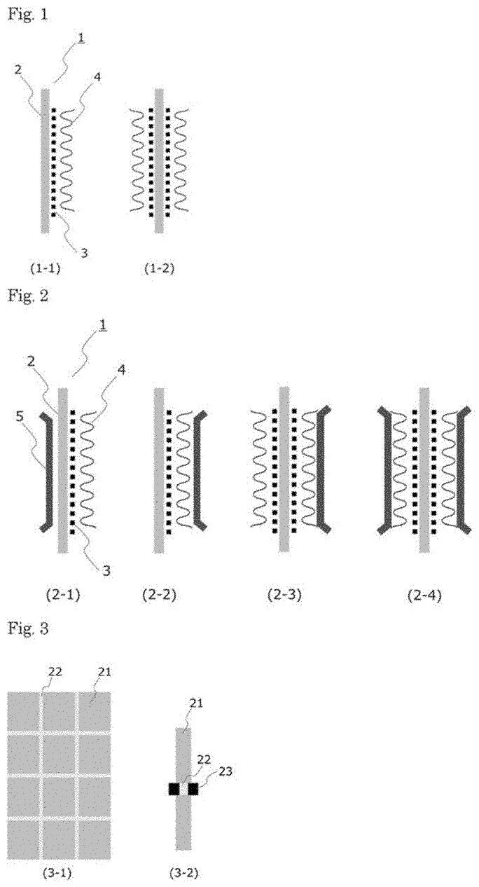

With respect to the Li ion recovery member according to the present embodiment, a possible mode and a preferred mode regarding an installation positional relationship of the permselective membrane, the electrodes, and the reticular elastic body will be described with reference to FIGS. 1 and 2.

Electrodes 3, i.e., a porous electrode or a membrane electrode, need to be provided on at least one main surface side of a permselective membrane 2, and these electrodes need to be sandwiched between a reticular elastic body 4 and the permselective membrane 2. Preferred examples of such a configuration include modes shown in (1-1) and (1-2) in FIG. 1. As shown in these figures, a mode in which the electrode 3, i.e., the porous electrode or the membrane electrode, is provided on one main surface side of the permselective membrane 2 and are sandwiched between the reticular elastic body 4 and the permselective membrane 2 can be obtained, or a mode in which the electrodes 3, i.e., the porous electrode or the membrane electrode are provided on both main surface sides of the permselective membrane 2 and are sandwiched between the reticular elastic body 4 and the permselective membrane 2 can be obtained. As shown in these figures, the electrode 3, i.e., the porous electrode or the membrane electrode, is preferably provided on the main surface of the permselective membrane 2 (provided so as to be in contact with the main surface).

Although not shown in these figures, when the electrodes are provided on both main surface sides of the permselective membrane, the electrode on one main surface side may be sandwiched by the reticular elastic body and the permselective membrane, and it is preferable that the electrodes 3 provided on both main surface sides are separately sandwiched by the reticular elastic body 4 and the permselective membrane 2, as shown in (1-2) in FIG. 1. Since the permselective membrane is made of an inorganic substance as described above, the breakage is more likely to occur as compared with the ion exchange membrane made of an organic substance. However, when the reticular elastic bodies are provided on both main surface sides of the permselective membrane, a pressure applied to the permselective membrane can be made uniform over the entire surface of the permselective membrane regardless of a current collector structure. Therefore, the breakage of the permselective membrane can be prevented from occurring. In addition, by pressing the electrodes with the reticular elastic body, disturbance can be formed in a flow of Li-containing liquid in the reticular elastic body, the number of times of contact of Li ions in the liquid with the surface of the permselective membrane can be increased, and improvement in Li recovery efficiency can be expected.

When the electrode made of the rigid conductive porous plate is further provided as the electrode other than the porous electrode or the membrane electrode described above, which is the at least one of the electrodes, a mode in which the electrode 3, i.e., the porous electrode or the membrane electrode, is provided on one main surface side of the permselective membrane 2 shown in (2-1) in FIG. 2, and an electrode 5 made of a rigid conductive porous plate is provided on the other main surface side of the permselective membrane 2 is shown as an example.

A mode in which the porous electrode or membrane electrode 3 and the rigid conductive porous plate 5 are provided on one main surface side of the permselective membrane 2 shown in (2-2) and (2-3) in FIG. 2 is also shown as an example. In this case, the rigid conductive porous plate 5 is preferably provided so as to sandwich the porous electrode or membrane electrode 3 and the reticular elastic body 4, that is, the porous electrode or membrane electrode 3, the reticular elastic body 4, and the rigid conductive porous plate 5 are preferably provided in this order when viewed from one main surface of the permselective membrane 2. With such a mode, the porous electrode or the membrane electrode is easily fixed so as to be in contact with the permselective membrane while preventing the occurrence of the breakage of not only the permselective membrane but also the electrodes, and the local stress is easily prevented.

A mode in which the porous electrode or membrane electrode 3 and the rigid conductive porous plate 5 are provided on both main surface sides of the permselective membrane 2 shown in (2-4) in FIG. 2 is also shown as an example. In this case, the installation positional relationship of the porous electrode or membrane electrode 3, the reticular elastic body 4, and the rigid conductive porous plate 5 is the same as (2-2) and (2-3) in FIG. 2, the rigid conductive porous plate 5 is preferably provided so as to sandwich the porous electrode or membrane electrode 3 and the reticular elastic body 4, that is, the porous electrode or membrane electrode 3, the reticular elastic body 4, and the rigid conductive porous plate 5 are preferably provided in this order when viewed from one main surface of the permselective membrane 2.

### [Li Recovery Device]

The Li recovery device according to the present embodiment includes a Li ion recovery electrolytic cell that includes the Li ion recovery member according to the present embodiment described above and that recovers Li ions by electrodialysis. The Li recovery device can recover Li ions from the raw liquid containing Li ions by using the Li ion recovery electrolytic cell including the Li ion recovery member according to the present embodiment described above.

### (Li Ion Recovery Electrolytic Cell)

The Li ion recovery electrolytic cell used in the present embodiment is preferably, for example, an electrolytic cell that includes a treatment cell that stores the raw liquid containing Li ions and a recovery liquid for recovering Li ions from the raw liquid, and the Li ion recovery member according to the present embodiment, has a configuration in which the raw liquid and the recovery liquid are partitioned and stored by the Li ion recovery member, and recovers Li ions in the recovery liquid by moving Li ions from the raw liquid to the recovery liquid via the permselective membrane of the Li ion recovery member.

Regarding a fact that the raw liquid and the recovery liquid stored in the treatment cell are partitioned and stored by the Li ion recovery member, one treatment cell may be partitioned by the Li ion recovery member into a raw liquid cell for storing the raw liquid and a recovery liquid cell for storing the recovery liquid, or a separate raw liquid cell and a separate recovery liquid cell may be connected so as to be partitioned by the Li ion recovery member.

The fact that the raw liquid and the recovery liquid are separated from each other by the Li ion recovery member means that the Li ion recovery member is provided such that the raw liquid is stored on one main surface side of the permselective membrane and the recovery liquid is stored on the other main surface side of the permselective membrane. As a result, Li ions in the raw liquid are recovered in the recovery liquid via the permselective membrane of the Li ion recovery member.

In the present embodiment, a pH of the raw liquid may be controlled. By controlling the pH, Li can be efficiently recovered regardless of a type of the raw liquid. In this case, the pH is preferably adjusted to a range of 9 or more and 15 or less, depending on the type of the raw liquid. The pH of 9 or more and 15 or less is an adjustment target, and in the present embodiment, for the pH of 9 or more and 15 or less, the pH of 9 of the raw liquid includes a value of 8.5 or more and less than 9.5 and the pH of 15 of the raw liquid includes a value of 14.5 or more and less than 15.5, and substantially means that the pH is in a range of 8.5 or more and less than 15.5.

When the pH of the raw liquid is controlled in the present embodiment, a method thereof is not particularly limited, and the pH may be controlled by, for example, a method of adding an alkaline aqueous solution to the raw liquid. The pH control of the raw liquid may be performed when Li ions are recovered in the recovery liquid, that is, the Li ions may be recovered in the recovery liquid while the pH control of the raw liquid is performed, or may be performed in advance before Li ions are recovered in the recovery liquid.

Preferred examples of an alkaline component in the alkaline aqueous solution used for adjusting the pH of the raw liquid include sodium hydroxide, lithium hydroxide, potassium hydroxide, rubidium hydroxide, cesium hydroxide, tetramethylammonium hydroxide, tetraethylammonium hydroxide, calcium hydroxide, barium hydroxide, europium (II) hydroxide, thallium (I) hydroxide, and guanidine. These alkaline components may be used alone or in combination of two or more. Among these, sodium hydroxide is more preferred from the viewpoint that a pH of a lithium ion extraction solution can be rapidly adjusted.

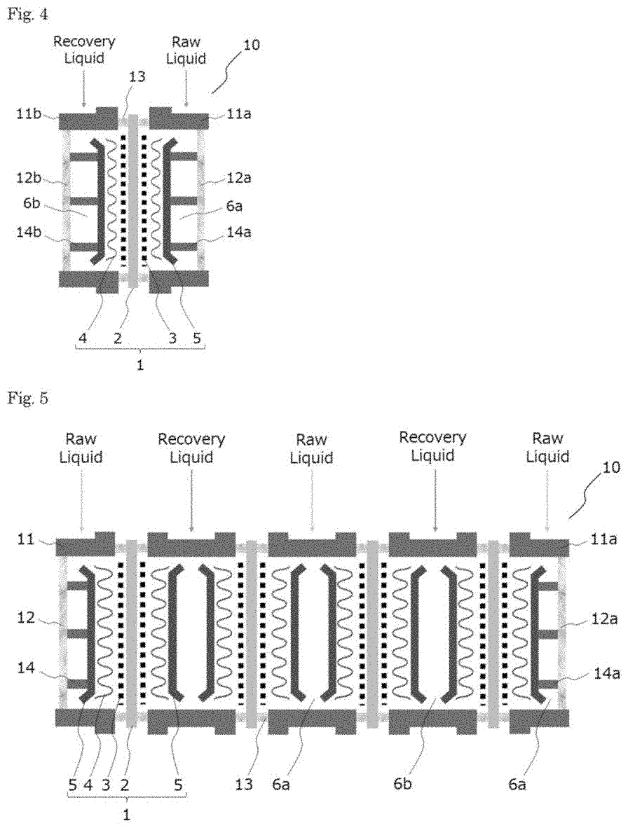

A preferred example showing a specific mode of the Li ion recovery electrolytic cell is shown in FIGS. 4 to 6.

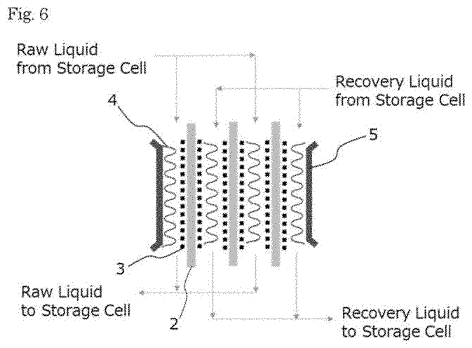

A Li ion recovery electrolytic cell 10 shown in FIG. 4 shows a cross section of one cell (unit cell) of a bipolar electrolyte, and a plurality of cells may be used in combination. The Li ion recovery electrolytic cell 10 shown in FIGS. 5 and 6 shows a mode having a plurality of Li ion recovery members 1.

For example, by combining a plurality of cells having one Li ion recovery member 1 shown in FIG. 4, or by incorporating a plurality of Li ion recovery members 1 in one cell, it is possible to cope with an increase in size even if each permselective membrane is small, and a required number of permselective membrane units can be combined according to a desired scale. Therefore, it is possible to more easily cope with the increase in size. In addition, the Li ion recovery electrolytic cell 10 shown in FIGS. 4 to 6 can be used in any of a unipolar type and a bipolar type.

FIG. 4 shows a cross section of the electrolytic cell 10 including the Li ion recovery member 1 according to the present embodiment shown in (2-4) in FIG. 2, and the electrolytic cell 10 includes an electrolytic cell frame 11, back partition walls 12a and 12b, a packing 13, and ribs 14a and 14b together with the Li ion recovery member shown in (2-4) in FIG. 2 including the permselective membrane 2, one electrode (porous electrode or membrane electrode) 3, the reticular elastic body 4, and the electrode (rigid conductive porous plate) 5. Two electrolytic cell frames 11a and 11b are combined via the packing 13 and the permselective membrane 2 to form the Li ion recovery electrolytic cell (one cell). In addition, an anode chamber 6a is provided as the raw liquid cell for storing the raw liquid, and a cathode chamber 6b is provided as the recovery liquid cell for storing the recovery liquid.

FIGS. 5 and 6 show cross sections of the Li ion recovery electrolytic cell 10 including a plurality of Li ion recovery members 1 shown in FIGS. 1 and 2 (FIG. 6 shows only a portion of the Li ion recovery member 1 in the Li ion recovery electrolytic cell 10), and shows a configuration in which a plurality of Li ion recovery members 1 are provided, and the plurality of the Li ion recovery members 1 are connected such that a main surface of the permselective membrane of one Li ion recovery member and a main surface of the permselective membrane of another Li ion recovery member face each other.

FIG. 5 shows the electrolytic cell 10 in which a plurality of Li ion recovery electrolytic cells 10 shown in FIG. 4 are connected to one another without back partition walls except for both ends, and the anode chambers 6a and the cathode chambers 6b respectively storing the raw liquid and the recovery liquid are alternately formed by two electrodes (rigid conductive porous plates) 5. The Li ion recovery electrolytic cell 10 shown in FIG. 5 has a preferred configuration since a constant capacity can be secured in the anode chamber 6a and the cathode chamber 6b by the two electrodes (rigid conductive porous plates) 5.

In addition, as shown in FIG. 6, a configuration in which a plurality of Li ion recovery members 1 in FIG. 4 are provided via the reticular elastic body may be adopted. The plurality of Li ion recovery members are fixed by the ribs 14 such that the members at both ends thereof are surrounded by the electrolytic cell frame 11 and the back partition wall 12. In the case of FIG. 6, the raw liquid and the recovery liquid are held in a portion of the reticular elastic body 4 surrounded by the permselective membrane 2.

Since the electrolytic cell frame 11 can be referred to as a frame of one cell, the electrolytic cell frame 11 is also referred to as a unit cell frame, and may be made of a metal such as carbon steel. Since the electrolytic cell frame 11 is assumed to be used in an alkaline atmosphere of the raw liquid containing Li ions or the like to be treated in the electrolytic cell, the electrolytic cell frame 11 may also be made of a reinforced plastic or the like having resistance to alkalinity.

The back partition wall 12 is provided to partition the cell from an adjacent cell when a plurality of electrolytic cells shown in FIG. 4 are used in combination, and is made of a metal such as Ti as the material having resistance to alkalinity.

When electricity is supplied from an adjacent cell through the back partition wall 12a in the bipolar type, electricity is supplied from the rib 14a to the electrodes 3 and 5 through the back partition wall 12a. Since the electrode on a side to which electricity is supplied functions as the anode, in this case, a portion partitioned by the back partition wall 12a, the electrolytic cell frame 11a, and the permselective membrane 2 serves as the anode chamber 6a, and the electrodes 3 and 5 present in the anode chamber 6a function as the anode. The raw liquid containing Li ions is stored in the anode chamber 6a.

On the other hand, a portion partitioned by the electrolytic cell frame lib, the back partition wall 12b, and the permselective membrane 2 serves as the cathode chamber 6b, and the electrodes 3 and 5 present in the cathode chamber 6b function as the cathode. The recovery liquid is stored in the cathode chamber 6b, and Li ions contained in the raw liquid are transferred from the raw liquid to the recovery liquid via the permselective membrane by applying electricity to the electrode and performing the electrodialysis, so that Li ions can be recovered in the recovery liquid. Therefore, the anode chamber 6a can be referred to as the raw liquid cell, and the cathode chamber 6b can be referred to as the recovery liquid cell.

In the modes of FIGS. 4 and 5, the raw liquid and the recovery liquid are supplied to the anode chamber 6a and the cathode chamber 6b through pipes, respectively, and Li ions in the raw liquid are recovered in the recovery liquid via the permselective membrane 2 of the Li ion recovery member. If necessary, as shown in FIG. 6, the pipes for recovering the raw liquid and the recovery liquid from the anode chamber 6a and the cathode chamber 6b, respectively, may be provided.

The Li recovery device according to the present embodiment is not particularly limited as long as the Li recovery device is provided with the Li ion recovery electrolytic cell including the Li ion recovery member having the above-described configuration. Specifically, it is preferable that the Li ion recovery electrolytic cell is connected by a pipe for supplying the raw liquid to the anode chamber thereof, a pipe for draining the raw liquid from the anode chamber, a discharge pipe for discharging a gas such as oxygen generated by the electrodialysis, a pipe for supplying the recovery liquid (water or the like to be newly supplied) to the cathode chamber, a pipe for draining the recovery liquid from which Li ions are recovered from the cathode chamber, a recovery pipe for recovering a gas such as hydrogen generated by the electrodialysis, or the like. In addition, the Li recovery device according to the present embodiment preferably includes a storage cell for the raw liquid and a storage cell for the recovery liquid to be supplied to the Li ion recovery electrolytic cell, a raw liquid waste liquid cell when the raw liquid is discharged, a recovery liquid waste liquid tank when the recovery liquid is discharged, an extraction and crystallization device for recovering Li from the recovery liquid containing Li ions recovered from the raw liquid, and the like, and these devices and the Li ion recovery electrolytic cell are connected to one another by the pipes described above.

It is preferable that each of the storage cells for the raw liquid and the recovery liquid includes a stirrer. Li ions can be more efficiently recovered by stirring, with the stirrer in each storage cell, the raw liquid and the recovery liquid circulating through the above pipes.

The Li recovery device according to the present embodiment may include a unit for circulating the raw liquid and the recovery liquid. Li ions can be more efficiently recovered. For example, as shown in FIG. 6, it is possible to adopt a unit for circulating the raw liquid in which the raw liquid is supplied to the anode chamber of the Li ion recovery electrolytic cell via the storage cell for the raw liquid and the raw liquid is drained from the anode chamber, or circulating the recovery liquid in which the recovery liquid is supplied to the cathode chamber of the Li ion recovery electrolytic cell via the storage cell for the recovery liquid and the recovery liquid from which the Li ions are recovered is drained from the cathode chamber.

For example, the circulation can be performed by manually or automatically turning on and off a pump, and may be continuously operated to be a continuous type, or may be intermittently operated to be a batch type. From the viewpoint of improving work efficiency, it is preferable to perform the automatic operation.

As described above, in order to control the pH of the raw liquid, a unit for adding the alkaline aqueous solution to the raw liquid may be provided. The unit may be a unit that allows the addition to be performed manually or automatically, continuously or intermittently, and may be provided in, for example, the storage cell for the raw liquid. From the viewpoint of the work efficiency, it is preferable to provide a unit capable of automatic operation.

Examples of the raw liquid used in the Li recovery device include a Li ion extraction solution extracted from a treatment member of a lithium secondary battery. The Li ion extraction solution is not particularly limited as long as the Li ion extraction solution is extracted from the treatment member, and examples thereof include a Li ion extraction solution extracted from a treatment member of a lithium secondary battery containing a sulfide-based solid electrolyte, that is, a Li ion extraction solution containing a sulfide-based solid electrolyte.

The Li recovery device according to the present embodiment may include, as necessary, a solid-liquid separation device for separating Li and water or the like generated by extraction and crystallization of Li from the recovery liquid. In addition, the Li recovery device may include a drying device for drying Li (for example, lithium carbonate or lithium hydroxide monohydrate described above) separated by the solid-liquid separation device.

### REFERENCE SIGNS LIST

1. Li ion recovery member
2. permselective membrane
3. one electrode (porous electrode or membrane electrode)
4. reticular elastic body
5. electrode (rigid conductive porous plate)
6a. raw liquid cell (anode chamber)
6b. recovery liquid cell (cathode chamber)
10. Li recovery electrolytic cell
11a, 11b. electrolytic cell frame
12a, 12b. back partition wall
13. packing
14a, 14b rib
21. permselective membrane unit
22. adhesive portion
23. current collector

1. A Li ion recovery member, comprising:
a permselective membrane including a Li ion conductor made of an inorganic substance;
electrodes; and
a reticular elastic body,
wherein the electrodes are provided on at least one main surface side of the permselective membrane,
wherein at least one of the electrodes is a porous electrode or a membrane electrode,
wherein the reticular elastic body has insulating properties, and
wherein the porous electrode or the membrane electrode is sandwiched between the reticular elastic body and the permselective membrane.

2. The Li ion recovery member of claim 1, wherein the porous electrode or the membrane electrode is provided on both main surface sides of the permselective membrane.

3. The Li ion recovery member of claim 1, further comprising:
an electrode made of a rigid conductive porous plate.

4. The Li ion recovery member of claim 3, wherein the porous electrode or the membrane electrode is provided on one main surface side of the permselective membrane, and the rigid conductive porous plate is provided on the other main surface of the permselective membrane.

5. The Li ion recovery member of claim 3, wherein the porous electrode or the membrane electrode and the rigid conductive porous plate are provided on one main surface side of the permselective membrane.

6. The Li ion recovery member of claim 3, wherein the porous electrode or the membrane electrode and the rigid conductive porous plate are provided on both main surface sides of the permselective membrane.

7. The Li ion recovery member of claim 5, wherein the rigid conductive porous plate is provided so as to sandwich the porous electrode or the membrane electrode and the reticular elastic body.

8. The Li ion recovery member of claim 1, wherein
the permselective membrane includes a plurality of permselective membrane units and an adhesive portion, which are disposed on a same plane,
the adhesive portion is provided in a lattice shape or a honeycomb shape, and
the plurality of permselective membrane units are disposed in regions partitioned by the adhesive portion and are bonded to one another by the adhesive portion.

9. The Li ion recovery member of claim 8, wherein the adhesive portion is provided with a current collector.

10. The Li ion recovery member of claim 1, wherein the Li ion conductor contains an oxide or oxynitride containing Li.

11. A Li recovery device, comprising:
a Li ion recovery electrolytic cell including the Li ion recovery member of claim 1 and configured to recover Li ions by electrodialysis.

12. The device of claim 11, further comprising:
a plurality of the Li ion recovery members, wherein
the plurality of Li ion recovery members are connected such that a main surface of the permselective membrane of one Li ion recovery member and a main surface of the permselective membrane of another Li ion recovery member face each other.
